(19) United States
(12) Patent Application Publication
(10) Pub. No.: US 2008/0232631 A1
(43) Pub. Date: Sep. 25, 2008

(54) MICROPHONE AND MANUFACTURING METHOD THEREOF

(75) Inventor: Peter V. Loeppert, Hoffmann Estates, IL (US)

Correspondence Address: FITCH EVEN TABIN AND FLANNERY, 120 SOUTH LA SALLE STREET, SUITE 1600, CHICAGO, IL, 60603-3406, US

(73) Assignee: KNOWLES ELECTRONICS, LLC, Itasca, IL (US)

(21) Appl. No.: 11/742,252

(22) Filed: Apr. 30, 2007

Related U.S. Application Data
(60) Provisional application No. 60/895,798, filed on Mar. 20, 2007.

(51) Int. Cl. H04R 9/08

(52) U.S. Cl. 381/361

(57) ABSTRACT

An apparatus for transducing between an acoustical signal and an electrical signal, comprises a backplate assembly comprising a charged layer and a conductive layer and a diaphragm assembly positioned at a predetermined distance from the backplate assembly. The diaphragm assembly comprising a support structure and a diaphragm, the diaphragm vibrates in response to an acoustical signal, is monolithically formed on the support structure, wherein the support structure and the diaphragm are composed of a common material having a thermomechanical property. The apparatus further comprises a spacer, a printed circuit board (PCB), and a housing. The spacer is formed between the backplate assembly and the diaphragm assembly, collectively constituting a motor portion. The motor portion and the PCB are disposed in the housing.

### CROSS-REFERENCE TO RELATED APPLICATION

This patent claims benefit under 35 U.S.C. §119 (e) to U.S. Provisional Application No. 60/895,798, filed Mar. 20, 2007 and entitled Silicon Electret Microphone and Manufacturing Method Thereof, the disclosure of which is hereby incorporated herein for all purposes.

### BACKGROUND

Conventional electret condenser microphones utilize metalized Mylar film stretched across and adhesively attached to a metal ring to serve as a diaphragm. The tension in this ring/film assembly is a major factor in determining the sensitivity of the microphone. Temperature and humidity changes affect the ring/film assembly and the adhesive that is used to attach the film to the ring is subject to creep. This leads to instability over time and environment changes. This is particularly a problem when using matched pairs as they tend to drift apart in performance over time. A need exists for a microphone having a ring/film assembly that expands equally as temperature changes and does not require any adhesive for the ring/film assembly attachment. Further, the film is less sensitive to humidity, thereby yielding a more stable performance over a period of time.

### BRIEF DESCRIPTION OF THE DRAWINGS

For a more complete understanding of the disclosure, reference should be made to the following detailed description and accompanying drawings wherein:

FIG. 1 is an exploded view illustrating a microphone assembly embodying the teachings of the present invention;

FIG. 2 is a perspective view of the microphone assembly of FIG. 1 embodying the teachings of the present invention;

FIG. 3 is an enlarged partial view of a motor portion of the microphone assembly shown in FIG. 1 embodying the teachings of the present invention;

FIGS. 4A-4D are cross-sectional views of a diaphragm assembly embodying the teachings of the present invention;

FIG. 5 is a sectional view illustrating the diaphragm assembly of FIG. 4D embodying the teachings of the present invention;

FIG. 6 is an enlarged sectional view of the diaphragm assembly shown in FIG. 5 embodying the teachings of the present invention; and

FIG. 7 is a top view of a wafer for forming a plurality of diaphragm assemblies embodying the teachings of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

While the present disclosure is susceptible to various modifications and alternative forms, certain embodiments are shown by way of example in the drawings and these embodiments will be described in detail herein. It will be understood, however, that this disclosure is not intended to limit the invention to the particular forms described, but to the contrary, the invention is intended to cover all modifications, alternatives, and equivalents falling within the spirit and scope of the invention defined by the appended claims.

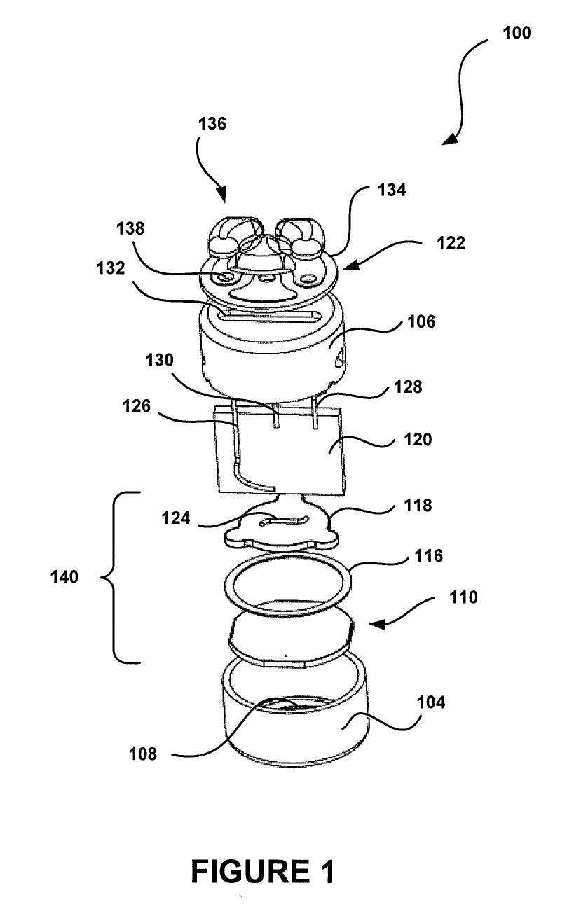

FIG. 1 illustrates an exploded view of a transducer 100 that can be used in virtually any type of listening devices such as earphones, headphones, Bluetooth wireless headsets, insert earphone, UWB wireless headsets, hearing aids, or the like. The hearing aids may be a behind-the-ear (BTE), in-the-ear (ITE), in-the-canal (ITC), completely-in-the-canal (CIC), combined BTE/ITE, combined BTE/ITC, combined BTE/CIC, or the like. Other types of listening device are possible. The transducer 100 may be a receiver, a speaker, a microphone, a combined receiver and microphone, dual microphones, depending on the desired applications. In the embodiment shown, the transducer 100 is a microphone. The microphone 100 comprises a housing having a top housing 106 and a bottom housing 104 attached together by any known techniques. The microphone 100 further comprises a diaphragm assembly 110, a spacer 116, and a backplate assembly 118, collectively constituting a motor portion 140. More details about the formation of the motor portion will follow.

At least one port 108 is formed on the bottom housing 104 by any known technique to allow acoustic waves to enter and interact with the motor portion 140 disposed within the housings 104, 106. An electronic device (not shown) mounted to a printed circuit board (PCB) 120 is disposed within the housings 104, 106. The electronic device may be an integrated circuit (IC) die, a capacitor, a resistor, an inductor, or other passive device, depending on the desired applications. It will be understood that one or more dies and electronic components may be included. In one embodiment, the device is a hybrid circuit. The hybrid circuit includes an impedance buffer circuit (not shown) such as, for example, a source-follower field effect transistor (FET) IC. The PCB 120 may include three connecting wires 126, 128, 130 that provide a ground, a power supply input, and an output for the processed electrical signal corresponding to a sound that is transduced by the motor portion of the microphone 100. As shown, a connecting wire 124 located on the motor portion 140 is electrically coupled to the PCB 120 via the connecting wire 126. When the PCB 120 and the motor portion 140 are placed in final or closed position within the bottom housing 104, the top and bottom housings 104, 106 are fixedly attached together locking the internal components in position. A flex circuit assembly 122 is then mounted to the top surface of the housing 102 for providing an electrical connection to the components within the listening devices (not shown). The flex circuit assembly 122 comprises a plurality of terminals 136 that provides a ground terminal, an output terminal, and a power terminal. A plurality of solder pads 138 on a flex circuit 134 of the assembly 122 are electrically connected to the terminals 136. The wires 126, 128, 130 of the PCB 120 extend through an opening 132 formed on the top housing 106 are electrically connected to the terminals 136 of the assembly 122.

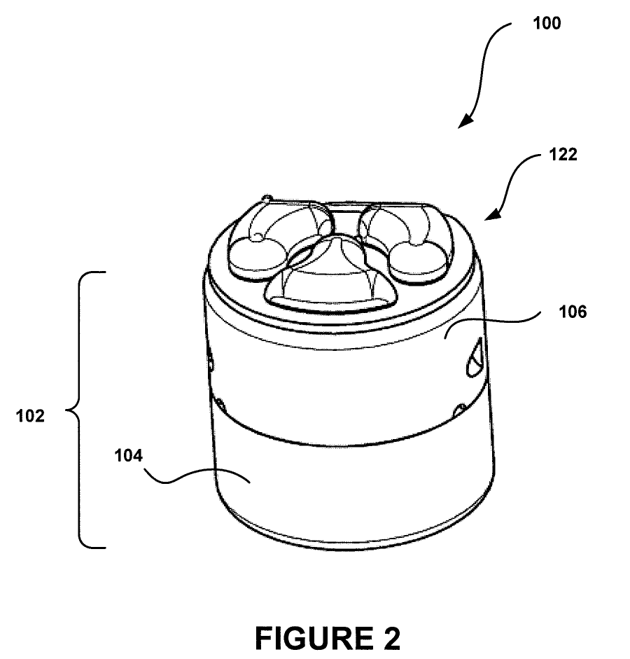

FIG. 2 illustrates a perspective view of a microphone 100 embodying the teachings of the present invention. A diaphragm assembly 110 (as shown in FIG. 1) as part of a motor portion 140 is disposed within a housing 102. A flex circuit assembly 122 is fixedly attached to the top surface of the housing 102. A housing 102 comprises a first housing 104 and a second housing 106 attached to the first housing 104 by known technique. While the housing 102 has a cylindrical shape, it will be understood that any housing shape or configuration suitable for any desirable applications may be suffice, including a roughly square shape, a rectangular shape or any other desired geometry and size. The housing 102 may be manufactured from a variety of materials such as, for example, stainless steel, alternating layers of conductive and non-conductive materials (e.g. metal particle-coated plastics), or the like.

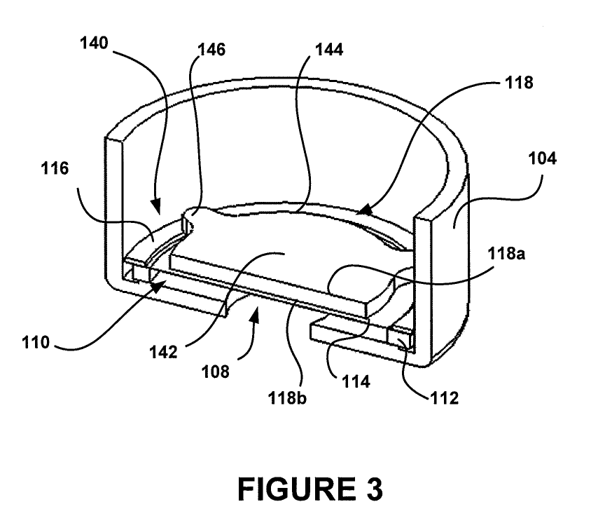

FIG. 3 illustrates a motor portion 140 disposed within a bottom housing 104 of a microphone 100 as depicted in FIG. 1. The motor portion 140 comprises a diaphragm assembly 110, a backplate assembly 118, and a spacer 116. The spacer 116 having a thickness is placed between the diaphragm assembly 110 and the backplate assembly 118. The spacer 116 is in the form of an annular ring shape and corresponds to the internal configuration of the bottom housing 104. It may typically be manufactured of an electrically insulating material such as polyethylene terephthalate (PET), polyimide, plastic, or the like. Other types of material are possible. Alternatively, the spacer may chosen from a set of metal like materials such as nickel or stainless steel.

The backplate assembly 118 in the form of a disc shape having a central portion 142, at least one relief section 144, three are illustrated in FIG. 1 and at least one protrusion 146, three are illustrated in FIG. 1, is mounted on the spacer 116. It will be understood that the backplate assembly 118 may take any form of shape or configuration suitable for any desirable applications may be suffice, including a roughly square shape, a disc shape, a rectangular shape or any other desired geometry and size with or without a backplate support and correspond to the configuration of the spacer 116. The backplate assembly 118 includes a conductive layer 118a and a charged layer 118b. The charged layer 118b may be chosen from a set of materials that are thermo-plastic materials with good charge storage characteristics, good chemical resistance, and high temperature stability. In one embodiment, the charged layer 118b may be a fluorinated ethylene propylene material commonly available under the trade name TEFLON, or any similar materials. Other types of material are possible. The conductive layer 118a is made of an electrically conductive material such as a stainless steel, gold, metal particle-coated polymer, or the like for transmitting signals from the charged layer 118b. Other types of material are possible. An optional polymer layer (not shown) may be attached to the conductive layer 118a by any known technique.

The diaphragm assembly 110 includes a support structure 112 and a diaphragm 114. More details about the formation of the diaphragm assembly will be discussed in greater detail therein. As shown in FIG. 3, the charged layer 118b of the backplate assembly 118 is directly exposed to the diaphragm 114 of the diaphragm assembly 110 and is separated from the diaphragm assembly by the spacer 116. The bottom surface of the support structure 112 is held in contact with the inner wall of the bottom housing 104. The diaphragm 114 of the diaphragm assembly 110 is typically exposed to an acoustic port 108 which is separated from the diaphragm 114 by the support structure 112. An optional damping element (not shown) may be attached to the bottom housing 104 to prevent debris from entering the bottom housing 104 through the port 108 that may damage the motor portion 140.

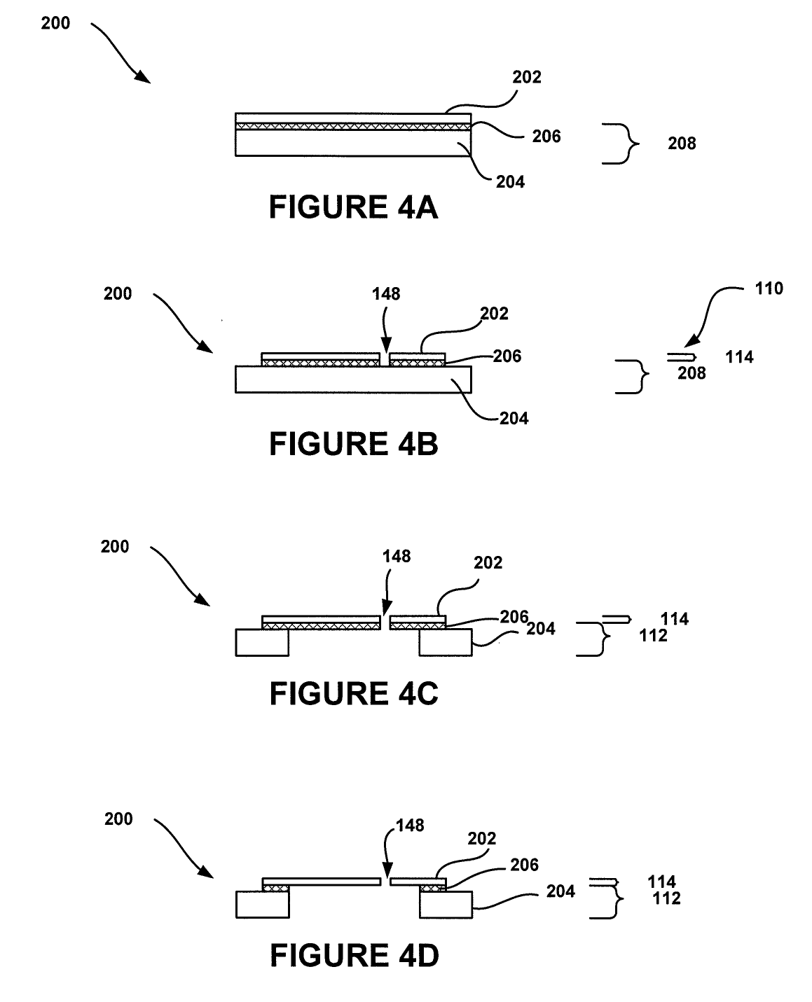

FIGS. 4A-4D illustrate one example of fabricating a diaphragm assembly 110 used in a microphone 100. Silicon on insulator (SOI) wafers 200, commonly available under the trade designation UNIBOND from Shin-Etsu Handotai Co., Ltd, or of any similar materials are provided. Other types of material are possible without departing the scope of the invention. The wafers 200 comprise a first layer of single crystal silicon 202 having a uniformed thickness of about 1 μm, an intermediate layer 206, and a handle wafer 204. The intermediate layer 206 is typically a silicon dioxide film; however, other film materials are possible. As shown in FIG. 4B, the first silicon layer 202 and the film 206 are etched on the perimeter using Reactive Ion Etching (RIE) (not shown). Other types of etching are possible. Alternatively, the perimeter of the film 206 may be etched in the final step of fabricating the diaphragm assembly 110 without departing the scope of the invention. A portion of the first layer 202 is selectively etched to form a pierce hole 148. More than one pierce hole may be possible for desired applications. A portion of the intermediate layer 206 exposed to the surrounding via the pierce hole 148 is then etched. The first layer 202 forms a diaphragm 114 of the diaphragm assembly 110.

Now, referring to FIG. 4C, the handle wafer 204 is then back-etched to form a support structure 112 of the diaphragm assembly 110. The etching process may be, for example, deep reactive ion etched (DRIE). Other types of etching are possible. A second surface of the film 206 exposed to the environment is then removed using any common etch solution (not shown), thereby releasing the diaphragm 114 as shown in FIG. 4D. As mentioned earlier, the perimeter of the film 206 and the second surface of the film 206 exposed to the environment are etched in a single process after the support structure 112 is formed.

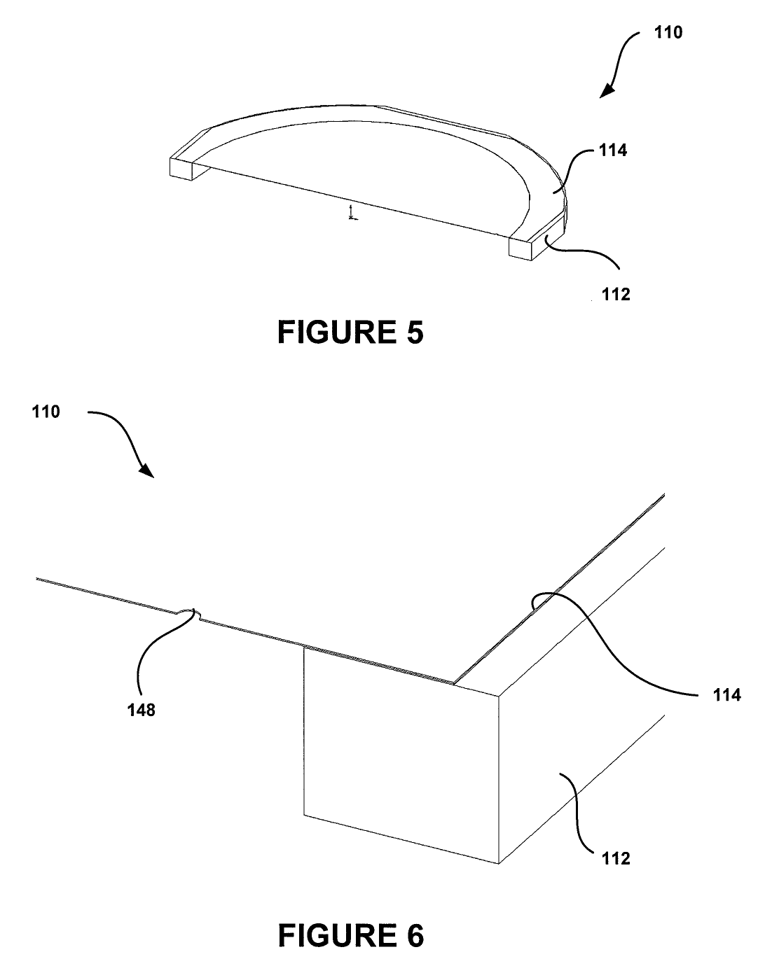

FIGS. 5-6 illustrate a diaphragm assembly 110 for a microphone 100. The diaphragm assembly 110 comprises a support structure 112 and a diaphragm 114. The support structure 112 in the form of an annular ring shape and corresponding to the internal configuration of the housing comprises an outer diameter of about 1.0 mm to 3.0 mm, such as approximately 3.0 mm, approximately 2.5 mm, approximately 2.2 mm, approximately 2.0 mm, approximately 1.5 mm, or approximately 1.0 mm. The support structure 112 has an inner diameter of about 0.5 mm to 2.0 mm, such as approximately 2.0 mm, approximately 1.8 mm, approximately 1.5 mm, approximately 1.0 mm, or approximately 0.5 mm. The thickness of the support structure is about 80 μm to 200 μm, such as approximately 200 μm, approximately 150 μm, approximately 125 μm, approximately 100 μm, or approximately 80 μm. The diaphragm 114 in the form of a disk is held in contact with the support structure 112 by the intermediate oxide layer 206 (See FIG. 4D). The thickness of the diaphragm 114 is about 0.5 μm to 2.0 μm, such as approximately 2.0 μm, approximately 1.5 μm, approximately 1.0 μm, or approximately 0.5 μm. It will be understood that the size of the support structure 112 and the thickness of the diaphragm 114 correspond to the configuration of the microphone, depending on the desired applications. A pierce hole 148 having a diameter of smaller than 75 μm, such as smaller than 60 μm, such as smaller than 50 μm, such as smaller than 40 μm, such as smaller than 30 μm, such as smaller than 20 μm, such as smaller than 15 μm, such as smaller than 13 μm, such as smaller than 10 μm, such as smaller than 8 μm, is formed on the diaphragm 114, as depicted in FIG. 6. The pierce hole 148 is used to control the low frequency roll-off of the microphone 100. One advantage of the silicon diaphragm assembly is that, no adhesive is required since the diaphragm and the support structure is fabricated in a single process. The silicon diaphragm assembly expands uniformly as temperature changes because the ring and diaphragm are composed of identical material. Furthermore the diaphragm does not respond to changes in humidity. Because the diaphragm assembly is a monolithic silicon structure, matching of pairs of transducers can be guaranteed for longer periods of time.

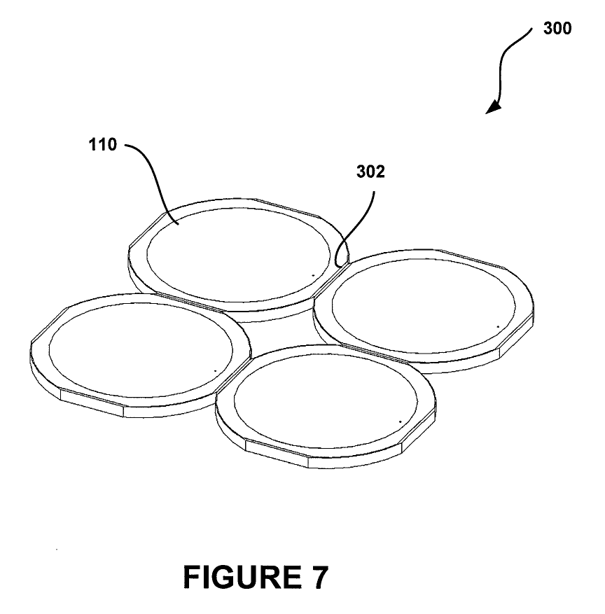

FIG. 7 illustrates a top view of a wafer 300 for forming a plurality of diaphragm assemblies. The wafer 300 is then mounted on a dicing tape (not shown) and subsequently diced along a dicing street 302 to produce a plurality of diaphragm assemblies 110. The dicing may be realized by using a saw, a laser, or by scribing and breaking. Other examples of dicing processes are possible.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An apparatus for transducing between an acoustical signal and an electrical signal, comprising:
a backplate assembly comprising a charged layer and a conductive layer; and
a diaphragm assembly positioned at a predetermined distance from the backplate assembly, the diaphragm assembly comprising a support structure and a diaphragm, the diaphragm vibrates in response to an acoustical signal, is monolithically disposed on the support structure, wherein the support structure and the diaphragm are formed from a common material.

2. The apparatus of claim 1, wherein the material is Silicon.

3. The apparatus of claim 1, wherein the diaphragm assembly is formed from a silicon-on-insulator wafer.

4. The apparatus of claim 1, wherein the support structure has a thickness of about 80 and about 200 um.

5. The apparatus of claim 1, wherein the support structure comprising an outer diameter and an inner diameter.

6. The apparatus of claim 5, wherein the outer diameter of the support structure is ranged between 1.0 to 3.0 mm.

7. The apparatus of claim 5, wherein the inner diameter of the support structure is ranged between 0.5 to 2.0 mm.

8. The apparatus of claim 3 wherein the diaphragm has a thickness of about 0.5 to 2.0 um.

9. The apparatus of claim 1, wherein a spacer is formed between the backplate assembly and the diaphragm assembly, defining a motor portion.

10. The apparatus of claim 9, wherein the spacer is formed of a material selected from the group consisting of polyethylene terephthalate (PET), polyimide, plastic, plastic composites, fiber reinforced plastic and combinations thereof.

11. The apparatus of claim 9, wherein the spacer is metal like material.

12. The apparatus of claim 1, wherein at least one pierce hole is formed on the diaphragm assembly to control the frequency, to provide barometric pressure, or combination thereof.

13. The apparatus of claim 12, wherein the pierce hole has a diameter of about 8 um and about 75 um.

14. The apparatus of claim 1, wherein the apparatus is a microphone.

15. A microphone for use in a hearing aid comprising:
a backplate assembly comprises a charged layer, the charged layer is fluorinated ethylene propylene-like material; and
a diaphragm assembly positioned at a predetermined distance from the backplate assembly, the diaphragm assembly comprising a support structure and a diaphragm, the diaphragm vibrates in response to an acoustical signal, is monolithically disposed on the support structure, the support structure and the diaphragm are formed of single crystal silicon;
wherein the backplate assembly and the diaphragm assembly are coupled together to form a motor portion.

16. The microphone of claim 15, wherein a spacer is formed between the backplate assembly and the diaphragm assembly.

17. The apparatus of claim 15, wherein the thickness of the support structure is about 125 um.

18. The apparatus of claim 15, wherein the support structure has an outer diameter of about 2.2 mm.

19. The apparatus of claim 15, wherein the support structure has an inner diameter of about 1.8 mm.

20. The apparatus of claim 15 wherein the diaphragm has a thickness of about 1 um.

21. The microphone of claim 15, wherein the backplate assembly comprising a conductive layer adjacent to the charged layer.

22. A method of forming a diaphragm assembly for use in a microphone, the diaphragm assembly having a support structure and a diaphragm, the method comprising:
providing silicon-on-insulator wafers having a first layer, an intermediate layer, and a handle wafer.
etching a perimeter of the first layer to form a diaphragm;
further selectively etching a hole through the first layer adjacent to the perimeter of the first layer to form a pierce hole;
selectively back-etching the handle wafer to form a support structure; and
removing a portion of the uncovered intermediate layer using an etchant to form a diaphragm suspended from the support structure.
